(19) United States
(12) Patent Application Publication
(10) Pub. No.: US 2019/0358900 A1
(43) Pub. Date: Nov. 28, 2019

(54) METHOD OF MAKING MULTI-PART ARTICLE

(71) Applicant: SABIC GLOBAL TECHNOLOGIES B.V., Bergen op Zoom (NL)

(72) Inventors: Scott Michael Davis, Washington, MA (US); Kim Loan Thi Ly, Pittsfield, MA (US); Alex Delaney, Pittsfield, MA (US); Keith Klinedinst, Dalton, MA (US)

(21) Appl. No.: 16/476,806

(22) PCT Filed: Jan. 9, 2018
(86) PCT No.: PCT/US2018/012955

§ 371 Date: Jul. 9, 2019

Related U.S. Application Data
(60) Provisional application No. 62/444,039, filed on Jan. 9, 2017.

(51) Int. Cl. B29C 64/176; B33Y 10/00; B33Y 30/00; B33Y 50/02; B29C 64/106; B29C 70/68; B29C 64/20; B29C 64/393

(52) U.S. Cl. CPC B29C 64/176; B33Y 10/00; B33Y 30/00; B29C 64/393; B29C 64/106; B29C 70/68; B29C 64/20; B33Y 50/02

(57) ABSTRACT

A method is disclosed for making an article with an additive manufacturing machine that includes a build platform (14) and an additive material dispensing nozzle (18) for controlled application of the additive material with respect to a location of the build platform. The method includes attaching a first part (24a) to the build platform. The first part includes a first mating surface that includes a protruding portion (34) and a recessed portion (32). A digital model of a second part that includes a second mating surface comprising recessed and protruding portions (39, 38) complementary to the first mating surface is inputted to the additive manufacturing machine. The nozzle dispenses and hardens an incremental quantity of a polymer material to the first mating surface according to the digital model, and successively-dispensed incremental quantities of polymer material are applied and hardened according to the digital model to produce the article including first and second parts.

### BACKGROUND

The fields of 3D printing and other forms of additive manufacturing involving the incremental formation of additive material have been the subject of significant technology developments. Additive manufacturing systems for polymers such as fused deposition modeling (FDM) can provide benefits such as relatively fine precision, scalability with some systems producing parts up to 2000 pounds (907 kg), and the availability of performance polymers capability of meeting performance specifications for a variety of demanding applications. However, as with many new technologies, the implementation of advanced additive manufacturing technologies can present problems to be addressed or opportunities for further advancement, and the field continues to be receptive to new ideas and implementations.

### BRIEF DESCRIPTION

In some embodiments, a method is provided for making an article with an additive manufacturing machine that includes a build platform and an additive material dispensing nozzle for controlled application of the additive material with respect to a location of the build platform. The method includes attaching a first part to the build platform. The first part includes a first mating surface that includes a protruding portion and a recessed portion. A digital model of a second part that includes a second mating surface comprising recessed and protruding portions complementary to the protruding and recessed portions of the first mating surface is inputted to the additive manufacturing machine. The additive material dispensing nozzle dispenses and hardens an incremental quantity of a polymer material to the first mating surface according to the digital model, and successively-dispensed incremental quantities of polymer material are applied and hardened according to the digital model to produce the article including first and second parts.

The above described and other features are exemplified by the following figures and detailed description.

### BRIEF DESCRIPTION OF THE DRAWINGS

The following figures are exemplary embodiments wherein the like elements are numbered alike.

FIG. 1 shows an example embodiment of an additive manufacturing machine.

FIG. 2 shows an example embodiment of a first part attached to an additive manufacturing machine build platform.

FIG. 3 shows an example embodiment of a second part attached to the first part from FIG. 2.

FIGS. 4A, 4B, and 4C each shows an article during a stage of a manufacturing process.

FIGS. 5A and 5B each shows example embodiments of an article including a recessed area of a first part that is partially filled.

FIGS. 6A and 6B each shows example embodiments of an article including a retention feature between first and second parts.

FIG. 7 shows an example embodiment of a part with multiple recessed portions.

FIG. 8 shows an example embodiment of a multi-part assembly with first, second, and third parts.

### DETAILED DESCRIPTION

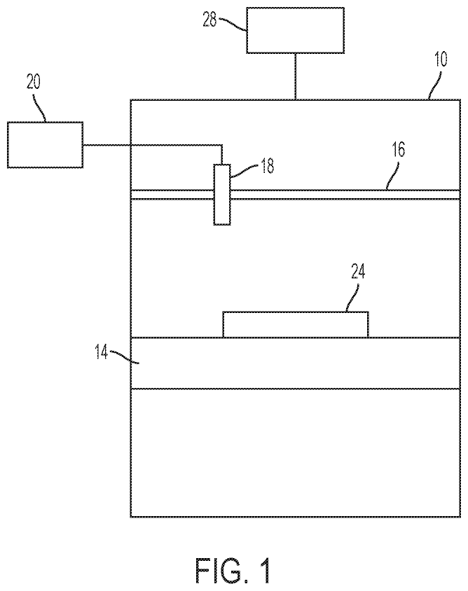

With reference to the Figures, an example embodiment of an additive manufacturing machine 10 that can utilize material extrusion additive manufacturing is shown in FIG. 1. As used herein, the term “material extrusion additive manufacturing” means the manufacture or fabrication of an article by any additive manufacturing technique that makes a three-dimensional solid object of any shape by laying down material in layers from hardener polymer material such as a thermoplastic material. Thermoplastic feed material can be provided from a polymer source material such as a monofilament or pellet heated to fluidize and be selectively dispensed through a nozzle such as an extrusion nozzle. For example, an extruded thermoplastic polymer material can be made by unwinding a thermoplastic polymer filament from a coil and feeding the filament to an extrusion head, which heats and dispenses the thermoplastic polymer material through an extrusion nozzle. In some embodiments, the additive polymer material can include a reinforcing material such as a fiber. These monofilament additive manufacturing techniques include fused deposition modeling and fused filament fabrication as well as other material extrusion technologies as defined by ASTM F2792-12a. Alternatively, a curable flowable polymer material (e.g., a fluid thermoset polymer composition) can be pressurized and delivered through a conduit to a nozzle (e.g., an extrusion or a spray nozzle depending on the viscosity of the thermoset polymer composition) for selective dispensing to a build surface.

Examples of polymer materials for additive manufacturing include but are not limited to polycarbonate (PC), acrylonitrile butadiene styrene (ABS), acrylic rubber, ethylene-vinyl acetate (EVA), ethylene vinyl alcohol (EVOH), liquid crystal polymer (LCP), methacrylate styrene butadiene (MBS), polyacetal (POM or acetal), polyacrylate and polymethacrylate (also known collectively as acrylics), polyacrylonitrile (PAN), polyamide (PA, also known as nylon), polyamide-imide (PAI), polyaryletherketone (PAEK), polybutadiene (PBD), polybutylene (PB), polyesters such as polybutylene terephthalate (PBT), polycaprolactone (PCL), polyethylene terephthalate (PET), polycyclohexylene dimethylene terephthalate (PCT), and polyhydroxyalkanoates (PHAs), polyketone (PK), polyolefins such as polyethylene (PE) and polypropylene (PP), fluorinated polyolefins such as polytetrafluoroethylene (PTFE) polyetheretherketone (PEEK), polyetherketoneketone (PEKK), polyetherimide (PEI), polyethersulfone (PES), polysulfone, polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), polyphenylsulfone, polytrimethylene terephthalate (PTT), polyurethane (PU), styrene-acrylonitrile (SAN), or any combination comprising at least one of the foregoing. The polymer material and its properties can be maintained constant throughout the manufacturing process or can be changed during the manufacturing process, e.g., by implementing a running change to a different glass transition temperature material or a different polymer blend or composition.

With specific reference now to FIG. 1, the additive manufacturing machine 10 includes a build platform 14, a guide rail system 16, an additive material dispensing nozzle 18 such as an extrusion nozzle for an additive polymer material, and an additive material supply source 20. The build platform 14 can be a support structure on which an article 24 can be built, and can move vertically (sometimes referred to as the z axis with respect to the article 24) based on signals provided from controller 28, which can be operated by a computer. In some embodiments, the build platform can be configured to move horizontally, or to move horizontally and vertically, or to be tilted at different angles. The guide rail system 16 as shown in FIG. 1 can move the nozzle 18 horizontally to a position along plane parallel to the guide rail system (sometimes referred to as the x-y axis with respect to the article 24) in a plane parallel to build platform 14 based on signals provided from controller 28. In some embodiments, the nozzle 18 can be configured to move vertically, or to move horizontally and vertically, or to be tilted at different angles.

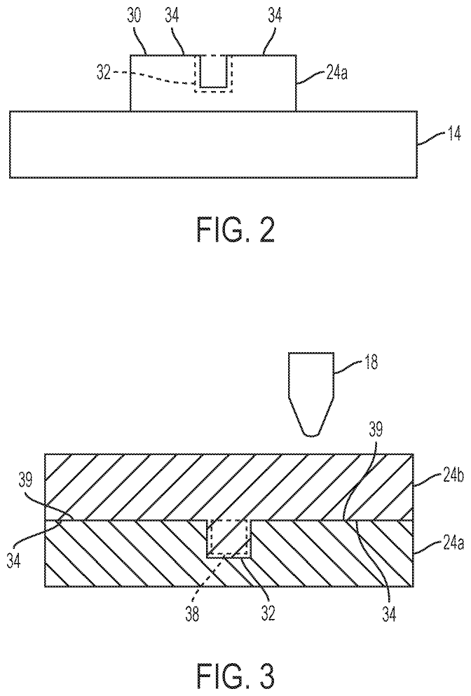

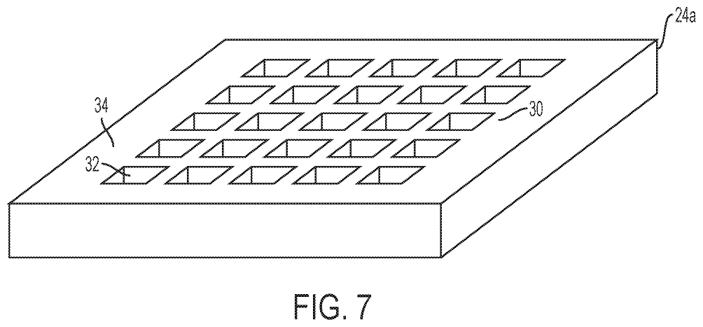

Turning now to FIG. 2, an example embodiment is shown of a front cross-sectional view of an example embodiment in which a first part 24a is attached or otherwise secured to the build platform 14. The attachment or securing of the first part 24a to the build platform 14 can be by any conventional attachment, including but not limited to clamps, threaded fittings or other fasteners, temporary adhesive, or by simple friction from the force of gravity urging the first part 24a into contact with the build platform 14. As further shown cross-sectional view in FIG. 2, the first part 24a includes a first mating surface 30 that includes a recessed portion 32 and a protruding portion 34. It can be noted here that although FIG. 2 shows only a single recessed portion 32, embodiments are contemplated in which a first mating surface can include a plurality of recessed portions and a plurality of protruding portions (see, e.g., FIG. 7). Also, it should be noted that although FIG. 2 shows the recessed portion as being enclosed at the bottom, it could be open with the bottom opening resting on a work platform 14 that is resists adhesion of the dispensed polymer of the second part 24b (FIG. 3).

As mentioned above, the method includes dispensing an incremental quantity of polymer material from the additive material dispensing nozzle to the first mating surface. FIG. 3 shows an example embodiment in which a polymer material has been successively incrementally dispensed from the nozzle 18 and hardened to form a second part 24b. In some embodiments, the deposition into and hardening of polymer material for a second part in the recessed portion of a first part attached or otherwise secured to a build platform can address problems with many prior art 3D printing systems and methods in which additive material is dispensed directly onto the build platform where it can be subject to dimensional instability caused by poor adhesion of the additive material to the build platform. Complementary recessed and protruding portions of the first and second parts can provide a macroscopic interlock between a second part under additive manufacturing construction and a first part which is itself attached or otherwise secured to the build platform. After completion of the additive manufactured second part, the completed multi-part article can be readily removed from the build platform without any compromise of the complementary recessed and protruding attachment between the first and second parts.

The shape of the second part 24b can be according to a digital model that has been inputted to the controller 28 (FIG. 1). Such digital models are well-known in the art, and do not require further detailed description here. The digital model can be generated from various types of computer aided design (CAD) software, and various formats are known, including but not limited to SLT (standard tessellation language) files, AMF (additive manufacturing format) files, PLY files, wavefront (.obj) files, and others that can be open source or proprietary file formats. As shown in FIG. 3, the shape of the second part 24b includes a second mating surface 36 including a protruding portion 38 and a recessed portion 39 that are complementary to the shape of the recessed portion 32 and the protruding portion 34 of the first part 24a.

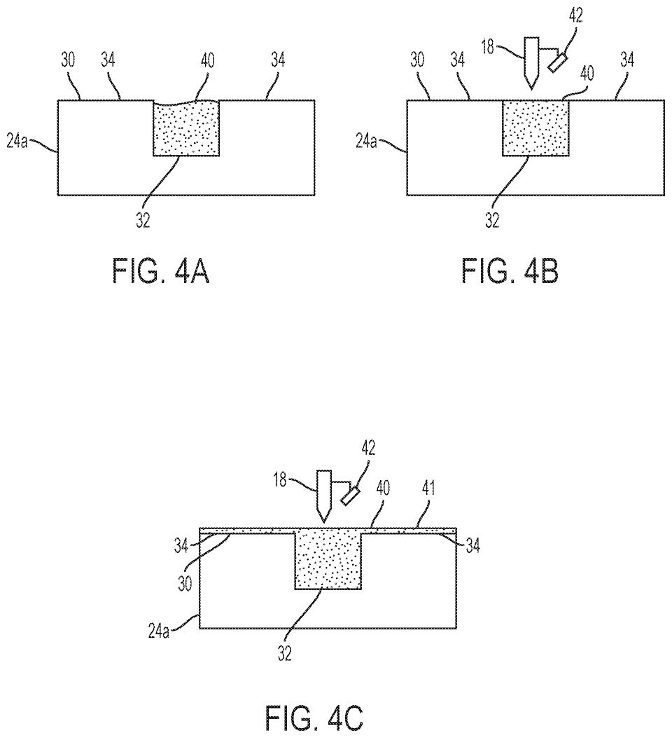

In some embodiments, as shown in FIG. 3, a first part recessed portion such as the recessed portion 32 can be filled with polymer material. In some embodiments, the recessed portion can be at least partially pre-filled with polymer material 40 before incrementally dispensing polymer material into the recessed portion from the nozzle 18. A cross-sectional front view of the recessed portion 32 partially pre-filled with polymer material is shown in FIG. 4A. In some embodiments, the surface of the partially pre-filled recessed portion 32 can be scanned (e.g., with an optical or other topographic scanner, which can be integrated with the nozzle 18 or separately mounted or controllably deployed from any structure of the machine 10) to identify the location of unfilled portions of the recessed portion 32. Those unfilled portions can be filled by incrementally dispensing polymer material from the nozzle 18 to fill the recessed portion 32 with polymer material 40 as shown in FIG. 4B. In some embodiments, the recessed portion 32 can be filled by the polymer pre-fill operation to arrive directly at the filled recessed portion of FIG. 4B. In some embodiments, the recessed portion 32 can be filled solely by incrementally dispensing polymer material from the nozzle 18 to fill the recessed portion 32 with polymer material 40 as shown in FIG. 4B. FIG. 4C shows the first part 24a with a layer 41 of incrementally dispensed polymer material 40 applied by nozzle 18 over the filled recessed portion 32 of FIG. 4B.

In some embodiments, polymer material deposited in the recessed portion of the first part 24a, whether by pre-filling or by incremental dispensing from the additive material dispensing nozzle, can be subjected to additional energy after deposition. In some embodiments, application of energy can promote the reduction or removal of gaps or bubbles in the recessed portion or to promote settling or fusion of the polymer material in the recessed portion. Examples of the application of energy include ultrasonic vibration, physical or fluid jet tamping, sub-sonic vibration, or heat energy. Energy can be provided by a component 42 such as a laser, heating element, transducer, or fluid jet, which can be integrated with the nozzle 18 as shown in FIGS. 4B and 4C, or can be separately mounted on or controllably deployed from any other component or structure of the machine 10.

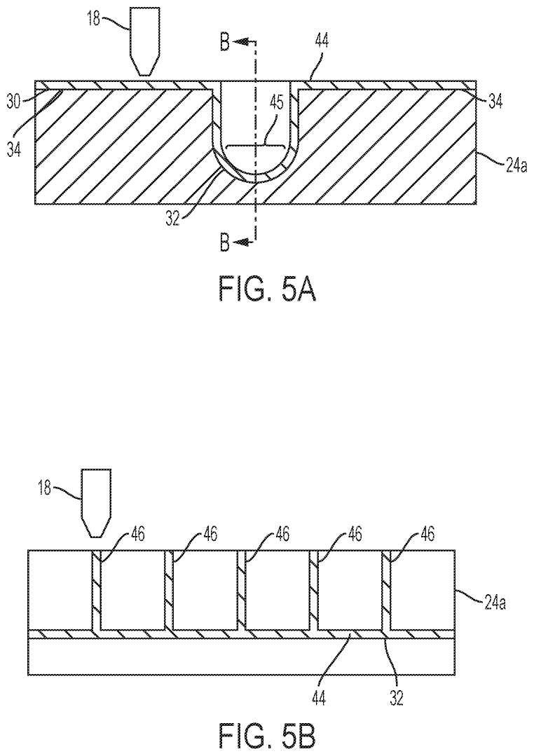

In some embodiments, the recessed portion of the first part 24a can be partially filled with hardened polymer material. In some embodiments, directed incremental dispensing and hardening of polymer material from the nozzle 30 can produce a portion of the second mating portion 36 as a layer 44 of polymer material on the recessed portion 32 of the first mating surface 30, as shown in the front cross-sectional view of FIG. 5A. In some embodiments, the recessed portion 32 can be partially filled with polymer material incrementally dispensed by the nozzle 18 to form a reinforced structure. For example, the bottom arcuate portion 45 of the polymer layer 44 in FIG. 5A is self-reinforcing. Another example of a reinforcing structure is shown in the cross-sectional side view of 5B taken on parting line B-B (FIG. 5A), which shows the recessed portion 32 in an extended trench configuration in which the second part protruding portion 38 includes reinforcing ribs 46 of hardened polymer material incrementally dispensed by the nozzle 18.

Other variations can be practiced according to this disclosure. For example, in some embodiments, an insert such as a metal insert can be disposed in the recessed portion 32 of first part 24a before or during pre-fill of the recessed portion 32 or before or during incremental dispensing of polymer material into the recessed portion 32 from the nozzle 18. In some embodiments, the first mating surface 30 or a portion of the first mating surface 30 can be heated before dispensing polymer material from the nozzle 18 or before pre-filling the recessed portion 32. Heat can be applied from a heater as component 42 or from a heater element (not shown) disposed elsewhere in a build chamber of the machine 10. In some embodiments, an adhesion promoter (e.g., adhesive, surface treatments such as corona discharge, or surface roughening such as physical roughening) can be applied to the first mating surface 30 or a portion thereof before dispensing polymer material. In some embodiments, a release agent (e.g., lubricant, silicone, or other surface treatment) can be applied to the first mating surface 30 or a portion thereof before dispensing polymer material.

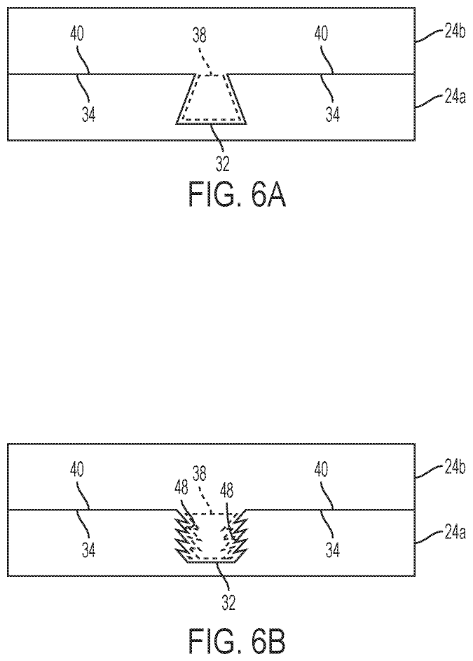

In some embodiments, the complementary protruding and recessed portions can cooperate to promote retention between the first part 24a and the second part 24b. For example, in the example embodiment shown in FIG. 6A, an interference fit between the first part recessed portion 32 and the hardened polymer material in the second part protruding portion 38 is provided by a shape of the first part recessed portion 32 that includes a horizontal cross-sectional area that varies inversely with distance from the build platform 14. In another example embodiment shown in FIG. 6B, an interference fit with surrounding deposited polymer material is provided by protruding structures 48 on the recessed portion 32 of the first mating surface 30.

The above example embodiments and figures have referred to singular recessed and protruding portions for each of the first and second parts 24a and 24b. Embodiments are also contemplated in which each of the first and second parts 24a and 24b can include a plurality of complementary recessed and protruding portions. An example of a first part 24a including a plurality of recessed portions 32 and a common protruding portion 34 is shown in perspective view in FIG. 7. FIG. 7 can also serve as a representation of a second part 24b, not shown but occupying the negative space in the recessed portions 32 and above the common protruding portion 34.

In some embodiments, the first and second parts 24a, 24b can be configured for permanent attachment to each other. In some embodiments, the first and second parts 24a, 24b can be configured to accommodate separation into the individual parts 24a and 24b after removal from the build platform 14. Examples of applications in which the parts could be separated include, but are not limited to, applications in which one of the parts serves as a mold for producing a targeted surface effect on the other part, applications in which one of the parts forms a protective cover for the other part during transit or storage and is removed when the first part is placed in service, or applications in which one of the parts is a consumable part in an end use application for the article and is targeted for removal and replacement.

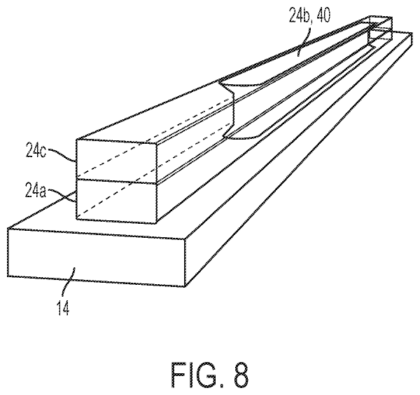

In some embodiments, the method can be used to attach two parts together. In some embodiments, the second part can be formed integrated to the first part and a third part, thus attaching the first part to the third part. With reference to FIG. 8, a first part 24a is shown secured to the build platform 14. A third part 24c is disposed adjacent to the first part. As shown in the example embodiment of FIG. 8, first and third parts 24a and 24c each include protruding and recessed portions, with the recessed portions cooperating to form a cavity occupied by the second part 24b formed by deposition of a polymer material 40. In the example embodiment of FIG. 8, the cavity shape shown in FIG. 8 has an hourglass shape to promote retention of the first and third parts 24a, 24c to the second part 24b, but could have any shape. Also, a shared cavity between the first and third parts is also an example embodiment of an optional feature, and deposition of polymer material can be used to adhere to and join any configuration of mating surface of first and third parts. Additionally, the number of parts being attached is not limited to two, and the above techniques can be used to attach multiple parts together.

Any of the above-described features can be used in combination. For example, temporary retention together of the parts 24a and 24b followed by separation could be facilitated by one or more features including a horizontal cross-sectional variation as shown in FIG. 6A in which one or both of the interfering recessed and protruding portions is optionally configured for deformation during separation, a release agent, or an adhesive agent, and it is noted that the different features that work counter to each other (e.g., a release agent combined with an interference fit feature) to provide a targeted balance of properties affecting separability of the parts.

This disclosure further encompasses the following numbered embodiments.

Embodiment 1. A method of making an article with an additive manufacturing machine that comprises a build platform and an additive material dispensing nozzle for controlled application of the additive material with respect to a location of the build platform, the method comprising:
attaching a first part to the build platform, the first part including a first mating surface that comprises a recessed portion and a protruding portion;
inputting a digital model of a second part that includes a second mating surface comprising protruding and recessed portions complementary to the protruding and recessed portions of the first mating surface;
dispensing and hardening an incremental quantity of a polymer material from the additive material dispensing nozzle to the first mating surface according to the digital model;
successively dispensing and hardening incremental quantities of polymer material according to the digital model to form the multi-part article; and
removing the article comprising first and second parts from the build platform.

Embodiment 2. The method of embodiment 1, wherein the recessed portion of the first part comprises a cavity.

Embodiment 3. The method of embodiments 1 or 2, further comprising filling the first mating surface recessed portion with polymer material.

Embodiment 4. The method any of embodiments 1-3, further comprising at least partially pre-filling the first part recessed portion with polymer material before dispensing the incremental portion of polymer material with the additive material dispensing nozzle.

Embodiment 5. The method of embodiments 4 or 5, further comprising scanning a partially filled first part recessed portion, and incrementally dispensing and hardening polymer material from the additive material dispensing nozzle to fill the first part recessed portion.

Embodiment 6. The method of any of embodiments 1-5, further comprising applying energy to polymer material in the recessed area of the first mating surface.

Embodiment 7. The method of embodiment 6, wherein the applied energy is selected from ultrasonic energy, physical tamping, heat energy.

Embodiment 8. The method of any of embodiments 1-3, wherein the first part recessed portion is partially filled with polymer material.

Embodiment 9. The method of embodiment 8, further comprising incrementally dispensing and hardening polymer material from the additive material dispensing nozzle to form a reinforced structure in the first part recessed portion.

Embodiment 10. The method of any of embodiments 1-9, further comprising disposing an insert in the first part recessed portion.

Embodiment 11. The method of any of embodiments 1-10, further comprising heating the first mating surface before dispensing the polymer material.

Embodiment 12. The method of any of embodiments 1-11, further comprising applying an adhesion promoter to the first mating surface before dispensing the polymer material.

Embodiment 13. The method of any of embodiments 1-11, further comprising applying a release agent to the first mating surface before dispensing the polymer material.

Embodiment 14. The method of any of embodiments 1-13, wherein the complementary protruding and recessed portions of the first and second parts cooperate to promote retention between the first and second parts.

Embodiment 15. The method of embodiment 14, wherein the recessed portion of the first part includes a surface feature that forms an interference with hardened polymer material in the first part recessed portion.

Embodiment 16. The method of any of embodiments 1-15, wherein the first mating surface and the second mating surface each include a plurality of complementary recessed and protruding portions.

Embodiment 17. The method of any of embodiments 1-16, further comprising separating the first part from the second part.

Embodiment 18. The method of any of embodiments 1-16, further comprising disposing a third part adjacent to the first part and securing the third part to the first part with hardened polymer material.

Embodiment 19. The method of embodiment 18, wherein the third part includes a third mating surface comprising protruding and recessed portions, wherein the recessed portions of the first and third parts cooperate to form a cavity.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method of making an article with an additive manufacturing machine that comprises a build platform and an additive material dispensing nozzle for controlled application of the additive material with respect to a location of the build platform, the method comprising:
attaching a first part to the build platform, the first part including a first mating surface that comprises a recessed portion and a protruding portion;
inputting a digital model of a second part that includes a second mating surface comprising protruding and recessed portions complementary to the protruding and recessed portions of the first mating surface;
dispensing and hardening an incremental quantity of a polymer material from the additive material dispensing nozzle to the first mating surface according to the digital model;
successively dispensing and hardening incremental quantities of polymer material according to the digital model to form the multi-part article; and
removing the article comprising first and second parts from the build platform.

2. The method of claim 1, wherein the recessed portion of the first part comprises a cavity.

3. The method of claims 1, further comprising filling the first mating surface recessed portion with polymer material.

4. The method of claims 1, further comprising at least partially pre-filling the first part recessed portion with polymer material before dispensing the incremental portion of polymer material with the additive material dispensing nozzle.

5. The method of claim 4, further comprising scanning a partially filled first part recessed portion, and incrementally dispensing and hardening polymer material from the additive material dispensing nozzle to fill the first part recessed portion.

6. The method of claims 1, further comprising applying energy to polymer material in the recessed area of the first mating surface.

7. The method of claim 6, wherein the applied energy is selected from ultrasonic energy, physical tamping, or heat energy.

8. The method of claims 1, wherein the first part recessed portion is partially filled with polymer material.

9. The method of claim 8, further comprising incrementally dispensing and hardening polymer material from the additive material dispensing nozzle to form a reinforced structure in the first part recessed portion.

10. The method of claim 1, further comprising disposing an insert in the first part recessed portion.

11. The method of claim 1, further comprising heating the first mating surface before dispensing the polymer material.

12. The method of claim 1, further comprising applying an adhesion promoter to the first mating surface before dispensing the polymer material.

13. The method of claim 1, further comprising applying a release agent to the first mating surface before dispensing the polymer material.

14. The method of claim 1, wherein the complementary protruding and recessed portions of the first and second parts cooperate to promote retention between the first and second parts.

15. The method of claim 14, wherein the recessed portion of the first part includes a surface feature that forms an interference with hardened polymer material in the first part recessed portion.

16. The method of claim 1, wherein the first mating surface and the second mating surface each includes a plurality of complementary recessed and protruding portions.

17. The method of claim 1, further comprising separating the first part from the second part.

18. The method of claim 1, further comprising disposing a third part adjacent to the first part and securing the third part to the first part with hardened polymer material.

19. The method of claim 18, wherein the third part includes a third mating surface comprising protruding and recessed portions, wherein the recessed portions of the first and third parts cooperate to form a cavity.
